(19) United States
(12) Patent Application Publication
(10) Pub. No.: US 2026/0185972 A1
(43) Pub. Date: Jul. 2, 2026

(54) TITRATION APPARATUS AND METHOD THEREOF

(71) Applicant: SAMSUNG ELECTRONICS CO., LTD., Suwon-si (KR)

(72) Inventors: Joonhyung LEE, Suwon-si (KR); Byung-Kwon Choi, Suwon-si (KR); Won Je Choi, Suwon-si (KR); Jun-suk Kwak, Suwon-si (KR); Eunsuk Kwon, Suwon-si (KR); Jeonghun Kim, Suwon-si (KR); Daewoong Han, Suwon-si (KR)

(73) Assignee: SAMSUNG ELECTRONICS CO., LTD., Suwon-si (KR)

(21) Appl. No.: 19/233,588

(22) Filed: Jun. 10, 2025

(30) Foreign Application Priority Data
Jan. 2, 2025 (KR) 10-2025-0000212

(51) Int. Cl. G01N 31/16

(52) U.S. Cl. CPC G01N 31/16

(57) ABSTRACT

A titration apparatus and method thereof may be provided. The titration apparatus may include an index table configured to support a sample container containing a sample, one or more reagent pumps configured to inject one or more reagents into the sample container, one or more sensors configured to measure characteristics of contents of the sample container including the sample, an electronic balance configured to support the sample container and measure a mass of the contents, and a controller configured to perform a titration process using at least one of the one or more reagent pumps, at least one of the one or more sensors, and the electronic balance.

### CROSS-REFERENCE TO RELATED APPLICATION

This application claims priority from Korean Patent Application No. 10-2025-0000212, filed on Jan. 2, 2025, in the Korean Intellectual Property Office, the entire disclosure of which is incorporated herein by reference for all purposes.

### BACKGROUND

### 1. Field

Methods and apparatuses consistent with embodiments of the disclosure relate to a titration apparatus and method thereof.

### 2. Description of Related Art

Titration is one of important operations in quantitative analysis and may be an experimental method of quantitative chemical analysis. The titration may be used to determine concentration of an analyte. A titrant, which is a standard solution with identified concentration and volume, may be used as a reagent. The titrant may react with the analyte. The titration may include acid-base titration, precipitation titration, and redox titration. An automated titration process using a titration apparatus may have advantages in terms of time and accuracy compared to a manual titration process.

### SUMMARY

One or more embodiments of the disclosure may address at least the above problems and/or disadvantages and other disadvantages not described above. Also, embodiments of the disclosure are not required to overcome the disadvantages described above, and an embodiment of the disclosure may not overcome any of the problems described above.

According to an aspect of the disclosure, a titration apparatus may include: an index table configured to support a sample container containing a sample; one or more reagent pumps configured to inject one or more reagents into the sample container; one or more sensors configured to measure characteristics of contents of the sample container including the sample; an electronic balance configured to support the sample container and measure a mass of the contents; and a controller configured to perform a titration process using at least one of the one or more reagent pumps, at least one of the one or more sensors, and the electronic balance.

According to an aspect of the disclosure, a titration method performed by a titration apparatus may include: measuring, by an electronic balance of the titration apparatus, an initial mass of contents of a sample container containing a sample; injecting, by a first reagent pump of the titration apparatus, a titrant into the sample container until a potential of hydrogen (pH) of the contents of the sample container becomes an intermediate pH, the intermediate pH being different from an initial pH of the contents and a target pH of the contents; injecting, by a second reagent pump of the titration apparatus after the injecting the titrant, ultrapure water into the sample container until a mass of the contents reaches a target mass; and injecting, by the first reagent pump after the injecting the ultrapure water, the titrant into the sample container until the pH of the contents reaches the target pH.

According to an aspect of the disclosure, a titration method performed by a titration apparatus may include: measuring, by an electronic balance of the titration apparatus, an initial mass of contents of a sample container containing a sample; injecting, by a first reagent pump of the titration apparatus, a titrant into the sample container until the contents of the sample container exceed an equivalence point; measuring a number of moles of the titrant in the contents at a moment when the contents reach the equivalence point; and determining a concentration of an analyte in the contents based on the number of moles of the titrant, a molecular weight of the analyte, and the initial mass.

Additional aspects of embodiments of the disclosure will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a diagram illustrating an example of a configuration of a titration apparatus, according to an embodiment;

FIG. 2 is a diagram illustrating an example of a sensor module and an electronic balance, according to an embodiment;

FIG. 3 is a diagram illustrating an example of a rinsing process in a rinsing space, according to an embodiment;

FIG. 4 is a diagram illustrating an example of a drying process in a drying space, according to an embodiment;

FIG. 5 is a diagram illustrating an example of a storage process in a storage space, according to an embodiment;

FIG. 6 is a flowchart illustrating an example of a pH calibration process of a titration apparatus, according to an embodiment;

FIG. 7 is a flowchart illustrating an example of a pH titration operation of a titration apparatus, according to an embodiment;

FIG. 8 a flowchart illustrating an example of a concentration titration operation of a titration apparatus, according to an embodiment;

FIG. 9 is a diagram illustrating an example of a structure of a titration apparatus, according to an embodiment; and

FIGS. 10 and 11 are flowcharts illustrating examples of a titration method, according to an embodiment.

### DETAILED DESCRIPTION

Hereinafter, non-limiting example embodiments of the discourse are described with reference to the accompanying drawings. Various alterations and modifications may be made to the example embodiments. Accordingly, embodiments of the disclosure are not limited to the example embodiments, and the disclosure should be understood to include all changes, equivalents, and replacements within the spirit and scope of the disclosure.

Although terms, such as “first,” “second,” and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “at least one of A and B,” “at least one of A, B, or C,” and the like, each of which may include any one of the items listed together in the corresponding one of the phrases, or all possible combinations thereof. For example, “at least one of A and B” indicates “A,” “B,” or “A, B, and C.”

Unless otherwise defined, all terms, including technical and scientific terms, used herein have the same meaning as commonly understood by one of ordinary skill in the art to which the disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, non-limiting example embodiments are described in detail with reference to the accompanying drawings. When describing the example embodiments with reference to the accompanying drawings, like reference numerals refer to like components and a repeated description related thereto may be omitted.

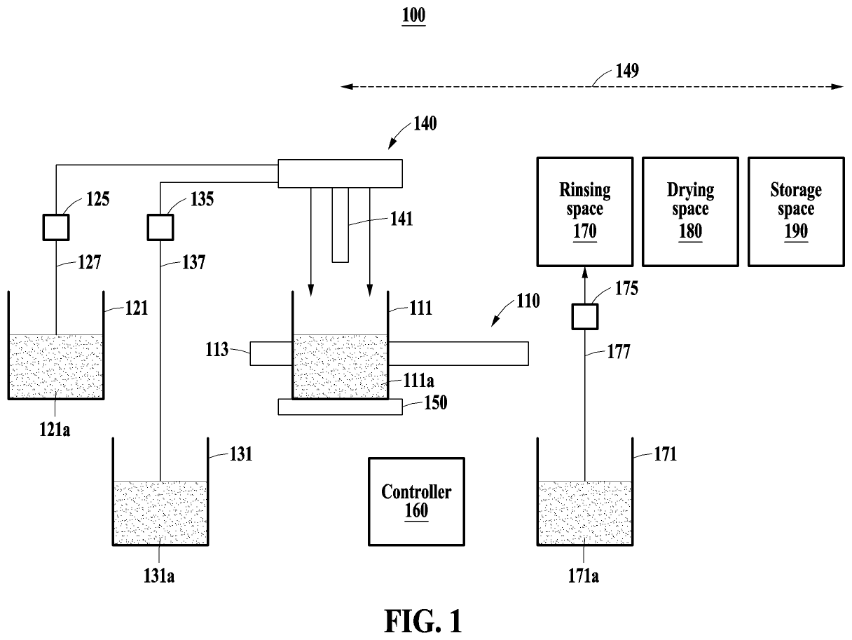

FIG. 1 is a diagram illustrating an example of a configuration of a titration apparatus, according to an embodiment. Referring to FIG. 1, a titration apparatus 100 may include an index table 113, one or more reagent pumps (e.g., a first reagent pump 125 and a second reagent pump 135), a sensor module 140, an electronic balance 150, and a controller 160. The titration apparatus 100 may be an automated titration apparatus. A titration result may be used as a reagent for semiconductor process materials that require potential of hydrogen (pH) titration (e.g., a reagent for a cleaning process or chemical mechanical polishing (CMP)).

The index table 113 may support a sample container 111 containing a sample. For example, the sample container 111 may be a vial but is not limited thereto. The index table 113 may be positioned in a measurement space 110. The index table 113 may include a plurality of holes in which sample containers are arranged. Titration may be performed on samples from the sample containers as the index table 113 rotates.

The one or more reagent pumps may include the first reagent pump 125 and the second reagent pump 135. However, the one or more reagent pumps may include one reagent pump or three or more reagent pumps. The one or more reagent pumps may inject one or more reagents (e.g., a titrant 121a and ultrapure water 131a) into the sample container 111. For example, a first reagent container 121 may contain the titrant 121a, and the first reagent pump 125 may inject the titrant 121a into the sample container 111 through a first tube 127. The titrant 121a may be a standard solution for titration. For example, a second reagent container 131 may contain the ultrapure water 131a, and the second reagent pump 135 may inject the ultrapure water 131a into the sample container 111 through a second tube 137. For example, the ultrapure water 131a may be deionized (DI) water but is not limited thereto. The controller 160 may identify an injection volume of the one or more reagents during a control and/or operation process of the one or more reagent pumps.

The sensor module 140 may measure properties of contents 111a of the sample container 111. The contents 111a may include the sample. The contents 111a may include the sample before the titration process is performed, and as the titration process is performed, the contents 111a may further include the titrant 121a and/or the ultrapure water 131a in addition to the sample. For example, the properties of the contents 111a may include at least one of pH, temperature, electric potential difference, and light intensity. However, embodiments are not limited thereto. The sensor module 140 may include one or more sensors that measure these properties. For example, the sensor module 140 may include at least one of a pH sensor, a temperature sensor, a potentiometric sensor, and a light sensor. However, embodiments are not limited thereto. The one or more sensors of the sensor module 140 may be moved toward the sample container 111 to be immersed in the contents 111a to measure the properties of the contents 111a.

The electronic balance 150 may be arranged at the bottom of the sample container 111 in the measurement space 110. The electronic balance 150 may support the sample container 111 and may measure the mass of the contents 111a. For example, the electronic balance 150 may be a weighing balance but is not limited thereto.

The electronic balance 150 may provide a mass quantitation-based titration process. A mass titration-based titration process may have higher accuracy than an accuracy of a volume quantitation-based titration process. In the volume quantitation-based titration process, errors may occur due to remaining liquid or environmental factors (e.g., temperature, evaporation, etc.). These errors may be eliminated in the mass titration-based titration process.

In addition, mass information may be provided in the mass-based titration process based on the electronic balance 150, and whether a target specification including target mass is satisfied may be easily evaluated based on the mass information. The target specification may be a target of titration. The target specification may be determined based on the type of the titration process. For example, the target specification of a pH titration process may include a target pH and the target mass of the contents 111a. The target specification of a concentration titration process may include target concentration and the target mass of the contents 111a. The concentration of the contents 111a may be the concentration of an analyte in the contents 111a.

The controller 160 may be electrically connected to one or more components of the titration apparatus 100 and may receive output of the one or more components of the titration apparatus 100. For example, the controller 160 may be electrically connected to one or more (e.g., some or all) of the index table 113, the one or more reagent pumps, the sensor module 140, and the electronic balance 150. The controller 160 may control at least one of the index table 113, the one or more reagent pumps, the sensor module 140, and the electronic balance 150 based on the electrical connection. The controller 160 may receive sensor output from the sensor module 140 and/or the electronic balance 150.

The controller 160 may perform the titration process using one or more (e.g., some or all) of the one or more reagent pumps, the sensor module 140, and the electronic balance 150. The titration process may be an automated titration process. The controller 160 may perform the pH titration process and/or the concentration titration process using the mass of the contents 111a measured using the electronic balance 150.

In the pH titration process, the controller 160 may measure initial mass of the contents 111a of the sample container 111 containing the sample using the electronic balance 150. When the pH titration process starts, the sample container 111 may be transferred onto the electronic balance 150. For example, the sample container 111 may be transferred by a transfer unit. The contents 111a before the pH titration process is performed may be a sample. The initial mass of the contents 111a may be the initial mass of the sample. The controller 160 may perform the pH titration process based on the initial mass of the contents 111a.

For example, the pH titration process may be based on a mass-based three-step titration algorithm that includes a first injection of the titrant 121a, an injection of the ultrapure water 131a, and a second injection of the titrant 121a. The controller 160 may firstly inject the titrant 121a into the sample container 111 using the first reagent pump 125 until a pH of the contents 111a becomes an intermediate pH based on a target pH. The intermediate pH may be significantly closer to the target pH compared to an initial pH of the contents 111a (e.g., the sample) before the pH titration process is performed. For example, the intermediate pH may differ from a final pH by a control margin. For example, the control margin may be one of ±0.1, ±0.2, ±0.3, ±0.4, and ±0.5, but embodiments are not limited thereto. For example, the intermediate pH may be the final pH ±0.2, but embodiments are not limited thereto.

The controller 160 may inject the ultrapure water 131a into the sample container 111 using the second reagent pump 135 until the mass of the contents 111a reaches target mass. The controller 160 may track the mass of the contents 111a using the electronic balance 150 and may inject the ultrapure water 131a into the sample container 111 until the mass of the contents 111a reaches the target mass. An injection amount of the ultrapure water 131a may be determined by subtracting the initial mass and a first injection amount of the titrant 121a from the target mass. As described above, the controller 160 may calculate the injection amount of the ultrapure water 131a and may inject the ultrapure water 131a based on the calculated injection amount of the ultrapure water 131a. The controller 160 may secondly inject the titrant 121a into the sample container 111 using the first reagent pump 125 until the pH of the contents 111a reaches the target pH. A second injection amount may be very small. The second injection amount of the titrant 121a may only affect the pH of the contents 111a and may have little effect on the mass of the contents 111a.

The controller 160 may evaluate whether the contents 111a satisfy the target specification (e.g., the target pH and the target mass) after the pH titration process of the mass-based three-step titration algorithm is performed. The controller 160 may measure the final pH of the contents 111a according to the pH titration process using the sensor module 140 (e.g., a pH sensor) and may measure the final mass of the contents 111a according to the pH titration process using the electronic balance 150. The controller 160 may determine whether the target specification is satisfied based on the final pH and the final mass. Based on these three pH titration processes, the contents 111a satisfying the target specification may be produced quickly, easily, and accurately.

In the concentration titration process, the controller 160 may measure the initial mass of the contents 111a of the sample container 111 containing the sample using the electronic balance 150. The contents 111a before the concentration titration process is performed may be a sample. The initial mass of the contents 111a may be the initial mass of the sample. The controller 160 may perform the concentration titration process based on the initial mass of the contents 111a.

For example, the concentration titration process may be based on a mass-based concentration titration algorithm. The controller 160 may inject the titrant 121a into the sample container 111 using the first reagent pump 125 until the contents 111a exceed an equivalence point and may measure the number of moles of the titrant 121a in the contents 111a at the moment when the contents 111a reach the equivalence point. The controller 160 may search for the equivalence point by injecting the titrant 121a into the sample container 111 until the equivalence point is exceeded and may measure the number of moles of the titrant 121a in the contents 111a at the moment when the contents 111a reach the equivalence point.

The controller 160 may determine the concentration of the analyte in the contents 111a based on the number of moles of the titrant 121a, a molecular weight of the analyte, and the initial mass. The analyte and the molecular weight of the analyte may be identified in advance. The controller 160 may determine the concentration of the analyte in the contents 111a by dividing the product of the number of moles of the titrant 121a and the molecular weight of the analyte by the initial mass. The concentration of the analyte may be expressed as in Equation 1 below.

$$wt ( \% ) = n\_t ( @ EPQ ) * M\_a / m\_s \qquad [ Equation 1 ]$$

In Equation 1, wt(%) may represent weight percent of the analyte indicating the concentration of the analyte, n_t may represent the number of moles of the titrant 121a, EPQ may represent the equivalence point, M_a may represent the molecular weight of the analyte, and m_s may represent the initial mass of the contents 111a. The initial mass of the contents 111a may be the mass of the sample.

According to an embodiment, the titration apparatus 100 may include a rinsing space 170 for rinsing the sensor module 140, a drying space 180 for drying the sensor module 140 after rinsing the sensor module 140, and a storage space 190 for storing the sensor module 140 after drying the sensor module 140. The sensor module 140 may be transferred along a transfer path 149 to the measurement space 110, the rinsing space 170, the drying space 180, and the storage space 190. The titration apparatus 100 may have a structure and configuration for transferring the sensor module 140. For example, the sensor module 140 may be transferred using a gantry robot. The sensor module 140 may be rinsed and dried in the rinsing space 170 and the drying space 180 before the titration process for each sample starts. When the titration process is completed, the sensor module 140 may be stored in the storage space 190.

The titration apparatus 100 may further include, in the rinsing space 170, a rinsing pump 175 that injects a rinsing solution 171a used to rinse the sensor module 140. For example, a rinsing solution container 171 may contain the rinsing solution 171a, and the rinsing pump 175 may inject the rinsing solution 171a into the rinsing space 170 through a third tube 177. The rinsing solution 171a injected into the rinsing space 170 may be discharged from the rinsing space 170 after the rinsing process is completed. For example, the ultrapure water 131a may be used as the rinsing solution 171a, but embodiments are not limited thereto.

When the sensor module 140 is transferred to the rinsing space 170, the one or more sensors of the sensor module 140 may be rinsed with the rinsing solution 171a. When the sensor module 140 is transferred to the drying space 180, a chemical solution attached to the one or more sensors of the sensor module 140 may be removed by a high-pressure nozzle in the drying space 180. When the sensor module 140 is transferred to the storage space 190, the one or more sensors of the sensor module 140 may be stored in a storage solution of the storage space 190. According to an embodiment, the titration apparatus 100 may include a capper that opens and closes lids of sample containers on the index table 113.

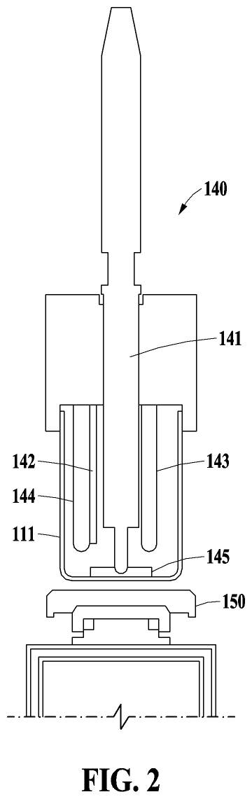

FIG. 2 is a diagram illustrating an example of a sensor module and an electronic balance, according to an embodiment. Referring to FIG. 2, the sensor module 140 may include the one or more sensors (e.g., a pH sensor 141 and a temperature sensor 144), one or more inlets (e.g., a first inlet 142 and a second inlet 143), and a stirrer 145. The pH sensor 141 may measure a pH of contents of the sample container 111. The temperature sensor 144 may measure temperature of the contents of the sample container 111. The stirrer 145 may mix the contents of the sample container 111. When the sensor module 140 is transferred to a measurement space, the sensor module 140 may be controlled so that the one or more sensors and the stirrer 145 are immersed in the contents of the sample container 111.

The first inlet 142 may be an end portion of a first tube (e.g., the first tube 127 of FIG. 1) used to inject a titrant (e.g., the titrant 121a of FIG. 1). The other end portion of the first tube (e.g., the first tube 127) may be immersed in a titrant (e.g., the titrant 121a) of a first reagent container (e.g., the first reagent container 121 of FIG. 1). The second inlet 143 may be an end portion of a second tube (e.g., the second tube 137 of FIG. 1) used to inject ultrapure water (e.g., the ultrapure water 131a of FIG. 1). The other end portion of the second tube (e.g., the second tube 137) may be immersed in ultrapure water (e.g., the ultrapure water 131a) of a second reagent container (e.g., the second reagent container 131 of FIG. 1). The electronic balance 150 may support the sample container 111. The mass of the contents of the sample container 111 may be measured using the electronic balance 150.

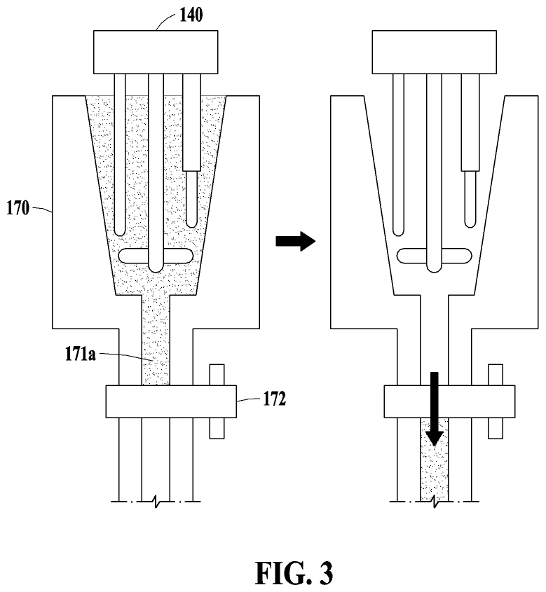

FIG. 3 is a diagram illustrating an example of a rinsing process in a rinsing space, according to an embodiment. Referring to FIG. 3, in a rinsing process, the rinsing solution 171a may be injected into the rinsing space 170. The rinsing space 170 may include a tank, and the rinsing solution 171a may be injected into the tank. When the sensor module 140 is transferred to the rinsing space 170, the sensor module 140 may be controlled so that one or more sensors (e.g., the one or more sensors of the sensor module 140) and a stirrer (e.g., the stirrer 145) are immersed in the rinsing solution 171a of the rinsing space 170. When the rinsing of the one or more sensors and the stirrer is completed, a discharge valve 172 may be controlled so that the rinsing solution 171a may be discharged from the rinsing space 170.

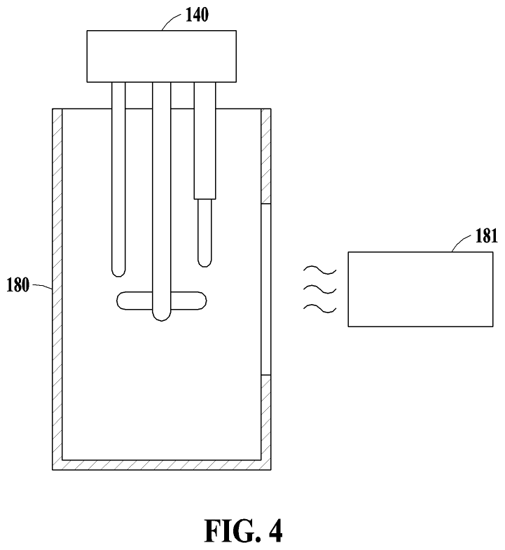

FIG. 4 is a diagram illustrating an example of a drying process in a drying space, according to an embodiment. Referring to FIG. 4, the sensor module 140 may be transferred to the drying space 180 for a drying process. A high-pressure nozzle 181 may spray high-pressure gas onto one or more sensors and a stirrer (e.g., the stirrer 145) of the sensor module 140 to remove a chemical solution remaining on the one or more sensors and the stirrer.

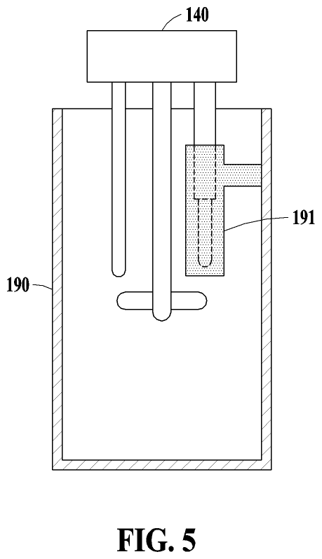

FIG. 5 is a diagram illustrating an example of a storage process in a storage space, according to an embodiment. Referring to FIG. 5, the sensor module 140 may be transferred to the storage space 190 for a storage process. The sensor module 140 may be stored with one or more sensors immersed in a storage solution of a storage container 191. For example, the storage solution may be potassium chloride but is not limited thereto.

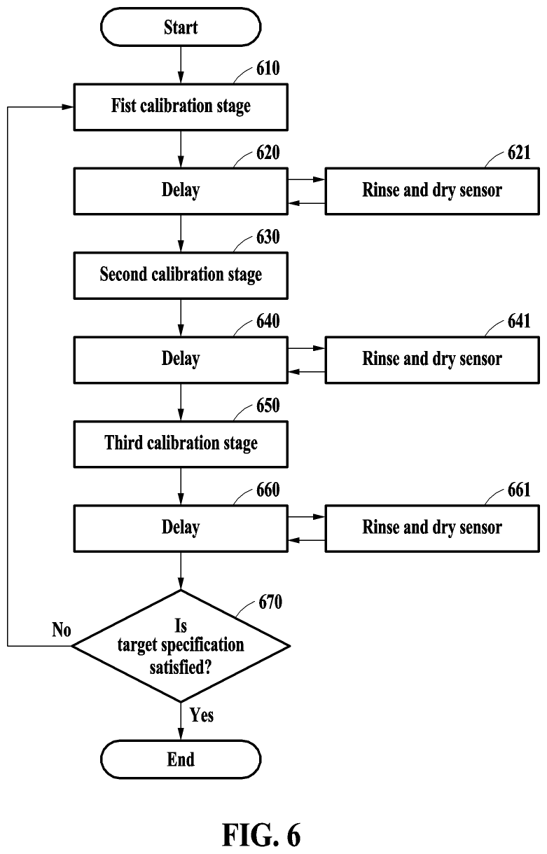

FIG. 6 is a flowchart illustrating an example of a pH calibration process of a titration apparatus, according to an embodiment. Referring to FIG. 6, the pH calibration process may be performed using a sensor in a storage state after rinsing and drying. A plurality of calibration stages of the pH calibration process may be performed using standard pH samples. The standard pH samples of different pH may be used in the plurality of calibration stages. The pH calibration may be performed based on an x-intercept and a slope of a straight line obtained by performing potentiometric measurement at each calibration stage.

A first calibration stage may be performed in an operation 610. For example, calibration to pH 4.0 may be performed using a standard pH sample of pH 4.0 in the first calibration stage. After the first calibration stage is completed, an operation 621 of rinsing and drying a sensor may be performed during a delay in an operation 620.

A second calibration stage may be performed in an operation 630. For example, calibration to pH 7.0 may be performed using a standard pH sample of pH 7.0 in the second calibration stage. After the second calibration stage is completed, an operation 641 of rinsing and drying a sensor may be performed during a delay in an operation 640.

A third calibration stage may be performed in an operation 650. For example, calibration to pH 10.0 may be performed using a standard pH sample of pH 10.0 in the third calibration stage. After the third calibration stage is completed, an operation 661 of rinsing and drying a sensor may be performed during a delay in an operation 660.

In the operation 660, it may be determined (e.g., by the controller 160) whether a target specification of the calibration is satisfied. When the target specification is not satisfied, the pH calibration process may be performed again from the operation 610. When the target specification is satisfied, the pH calibration process may be terminated. After the pH calibration process is terminated, a titration process may be performed.

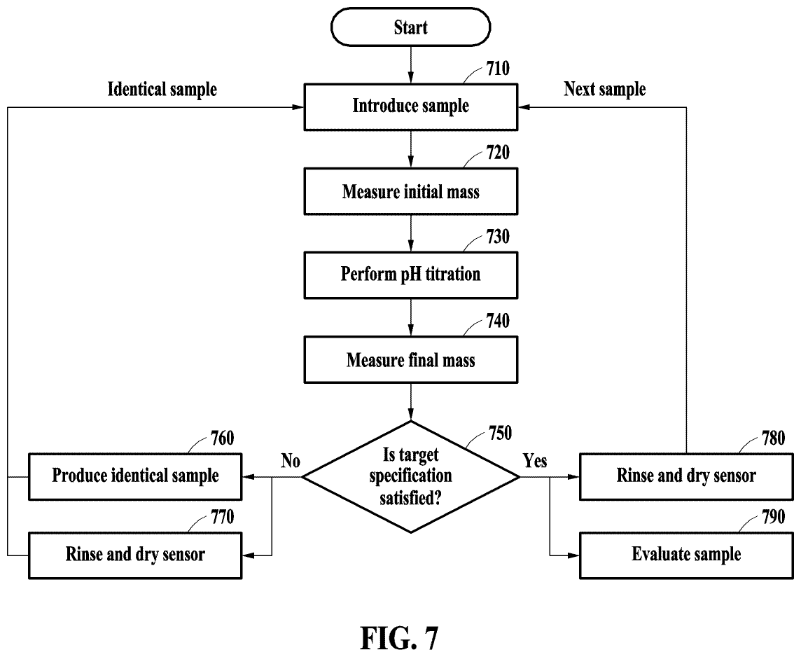

FIG. 7 is a flowchart illustrating an example of a pH titration operation of a titration apparatus, according to an embodiment. Referring to FIG. 7, a sample is introduced in an operation 710. A sample container (e.g., the sample container 111 of FIG. 1) containing the sample may be introduced onto an index table (e.g., the index table 113 of FIG. 1) and then onto an electronic balance (e.g., the electronic balance 150 of FIG. 1). Initial mass measurement may be performed in an operation 720. In the operation 720, initial mass of the sample may be measured.

In an operation 730, pH titration may be performed. The pH titration may be performed based on a mass-based three-step titration algorithm. The three-step titration algorithm may include a first injection of a titrant (e.g., the titrant 121a of FIG. 1), an injection of ultrapure water (e.g., the ultrapure water 131a of FIG. 1), and a second injection of the titrant. In the first injection, the titrant may be injected into the sample container until a pH of contents of the sample container becomes an intermediate pH based on a target pH. The intermediate pH may differ from a final pH by a control margin (e.g., a final pH ±0.2). The ultrapure water may be injected into the sample container until the mass of the contents reaches target mass. In the second injection, the titrant may be injected into the sample container until the pH of the contents of the sample container becomes the target pH.

In an operation 740, final mass measurement may be performed. In the operation 740, final mass of the contents may be measured. In an operation 750, it may be determined (e.g., by the controller 160) whether a target specification of the pH titration is satisfied. When the target specification is not satisfied, operations 760 and 770 may be performed. In the operation 760, a sample identical to the sample in operation 710 may be produced. A controller (e.g., the controller 160) may command a sample production apparatus to produce an identical sample. When a previously produced identical sample exists, operation 760 may be omitted. Contents that do not satisfy the target specification may be discarded. In the operation 770, sensor rinsing and drying may be performed (e.g., in the rinsing space 170 and the drying space 180 of FIG. 1, respectively). After the operations 760 and 770 are performed, operation 710 may be performed again based on the identical sample.

When the target specification is satisfied, operations 780 and 790 may be performed. In the operation 780, sensor rinsing and drying may be performed (e.g., in the rinsing space 170 and the drying space 180 of FIG. 1, respectively). When a next sample exists, the operation 710 may be performed based on the next sample. When the next sample does not exist, sensor storage may be performed (e.g., in the storage space 190 of FIG. 1). Sample evaluation may be performed in an operation 790. The sample evaluation may be performed by a sample evaluation apparatus.

Table 1 below shows an example of pH titration results based on recipes 1 to 4. Initial mass of the sample produced before titration may be 35.84 g, and an initial pH may be 7.3. The intermediate pH for the first injection of the titrant may be 7.3.

TABLE 1

| | Recipe 1 | | Recipe 2 | | Recipe 3 | | Recipe 4 | |
|---|---|---|---|---|---|---|---|---|
| Experiment | Final | Final | Final | Final | Final | Final | Final | Final |
| number | pH | mass (g) | pH | mass (g) | pH | mass (g) | pH | mass (g) |
| 1 | 7.503 | 40.02 | 7.504 | 40.01 | 7.503 | 39.99 | 7.503 | 39.97 |
| 2 | 7.503 | 40 | 7.503 | 40.06 | 7.502 | 40.01 | 7.501 | 40.03 |
| 3 | 7.504 | 40.03 | 7.503 | 40.02 | 7.502 | 40 | 7.502 | 40.01 |
| 4 | 7.502 | 39.98 | 7.502 | 40.02 | 7.503 | 40.01 | 7.502 | 40.01 |
| 5 | 7.501 | 40.01 | 7.503 | 40.02 | 7.502 | 40.02 | 7.502 | 40.08 |
| 6 | 7.502 | 40.01 | 7.502 | 40 | 7.501 | 39.98 | 7.503 | 40.03 |
| 7 | 7.502 | 39.99 | 7.501 | 40.01 | 7.501 | 40 | 7.502 | 40.01 |
| 8 | 7.504 | 40 | 7.502 | 40.01 | 7.501 | 40.02 | 7.503 | 40.02 |
| 9 | 7.503 | 40 | 7.502 | 40 | 7.502 | 40.01 | 7.502 | 40.01 |
| 10 | 7.503 | 40.01 | 7.502 | 40.02 | 7.503 | 40.01 | 7.505 | 40.01 |

According to an embodiment, the controller (e.g., the controller 160) may independently perform a titration process for each experiment number. According to an embodiment, the controller may design the titration process of a next experiment number by considering a titration result of a previous experiment number. For example, the controller may control an injection amount (e.g., a first injection amount of the titrant, an injection amount of ultrapure water, and a second injection amount of the titrant) of a reagent so that an error in the titration result of the previous experiment number is reduced.

Table 2 below shows an example of pH titration results and target specifications based on recipes 1 to 4.

TABLE 2

| Experiment | Target | Target mass | Average | Average mass |
|---|---|---|---|---|
| number | pH | (g) | pH | (g) |
| 1~10 | 7.5 | 40 | | |
| Average | | | 7.5025 | 40.015 |
| CV(%) | | | 0.01225 | 0.04475 |
| MAE | | | 0.0024 | 0.01575 |

In Table 2, CV may represent a coefficient of variation, and MAE may represent a mean absolute error.

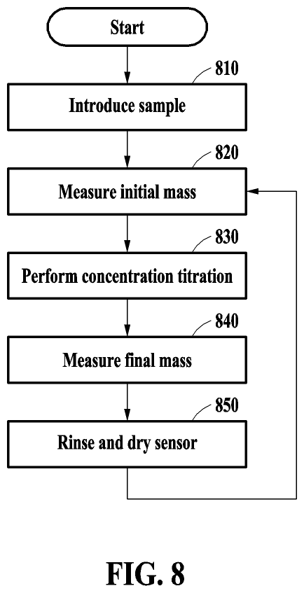

FIG. 8 a flowchart illustrating an example of a concentration titration operation of a titration apparatus, according to an embodiment. Referring to FIG. 8, a sample may be introduced in an operation 810. A sample container (e.g., the sample container 11 of FIG. 1) containing the sample may be introduced onto an index table (e.g., the index table 113 of FIG. 1) and then onto an electronic balance (e.g., the electronic balance 150 of FIG. 1). Initial mass measurement may be performed in an operation 820. In the operation 820, initial mass of the sample may be measured.

In an operation 830, concentration titration may be performed. The concentration titration may be performed based on a mass-based concentration titration algorithm. For the concentration titration, a titrant (e.g., the titrant 121a of FIG. 1) may be injected into the sample container until contents of the sample container exceed an equivalence point. The number of moles of the titrant in the contents may be measured at the moment when the contents reach the equivalence point. The concentration of an analyte in the contents may be determined based on the number of moles of the titrant, a molecular weight of the analyte, and initial mass. The concentration of the analyte in the contents may be determined by dividing the product of the number of moles of the titrant and the molecular weight of the analyte by the initial mass.

In an operation 840, final mass measurement may be performed. In the operation 840, final mass of the contents may be measured. Based on the final mass, it may be determined (e.g., by the controller 160) whether a target specification of the concentration titration is satisfied. In the operation 850, sensor rinsing and drying may be performed (e.g., in the rinsing space 170 and the drying space 180 of FIG. 1, respectively).

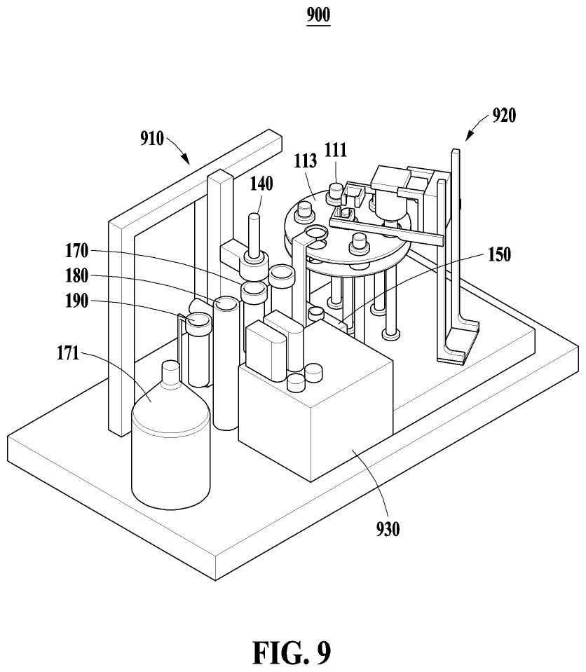

FIG. 9 is a diagram illustrating an example of a structure of a titration apparatus, according to an embodiment. Referring to FIG. 9, a titration apparatus 900 may include the sample container 111, the index table 113, a gantry robot 910, a capper 920, the sensor module 140, the electronic balance 150, a reagent space 930, the rinsing space 170, the rinsing solution container 171, the drying space 180, and the storage space 190.

The gantry robot 910 may transfer the sensor module 140 along two axes (e.g., X-axis and Y-axis). The two axes may be, for example, horizontal axes, but are not limited thereto. For example, the gantry robot 910 may transfer the sensor module 140 to one of the index table 113 (e.g., a measurement space), the rinsing space 170, the drying space 180, and the storage space 190. The capper 920 may open and close lids of sample containers on the index table 113. The reagent space 930 may include one or more reagent containers containing one or more reagents and one or more reagent pumps.

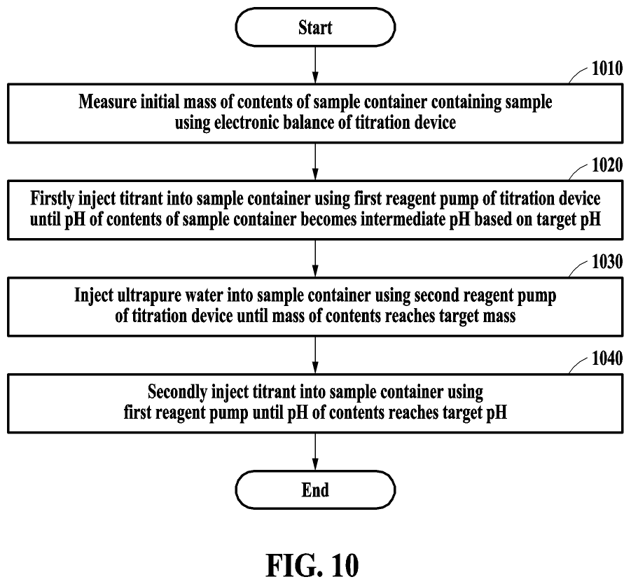

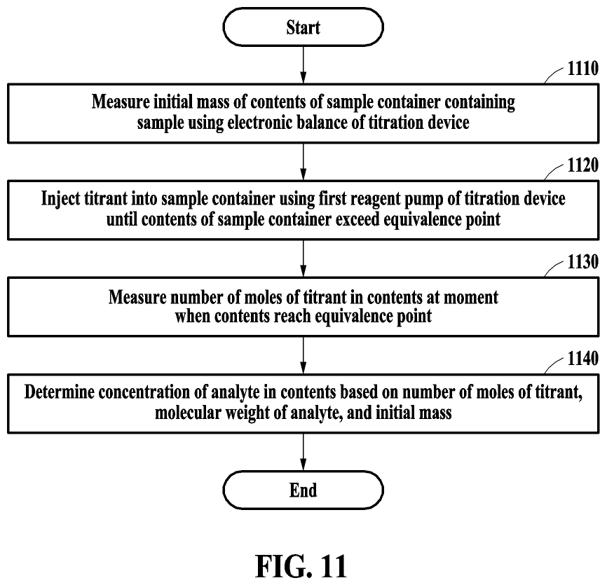

FIGS. 10 and 11 are flowcharts illustrating examples of a titration method, according to an embodiment. Referring to FIG. 10, in an operation 1010, a titration apparatus (e.g., a controller, such as the controller 160) may measure initial mass of contents of a sample container containing (e.g., the sample container 111) a sample using an electronic balance (e.g., the electronic balance 150) of the titration apparatus. In an operation 1020, the titration apparatus may inject a titrant (e.g., the titrant 121a) into the sample container using a first reagent pump (e.g., the first reagent pump 125) of the titration apparatus until a pH of the contents of the sample container becomes an intermediate pH based on a target pH. In an operation 1030, the titration apparatus may inject ultrapure water (e.g., the ultrapure water 131a) into the sample container using a second reagent pump (e.g., the second reagent pump 135) of the titration apparatus until mass of the contents reaches target mass. In an operation 1040, the titration apparatus may again inject the titrant into the sample container using the first reagent pump until the pH of the contents reaches the target pH.

An injection amount of the ultrapure water may be determined (e.g., by the controller 160) by subtracting the initial mass and a first injection amount of the titrant from the target mass.

The titration apparatus may measure a final pH of the contents using the sensor module (e.g., the sensor module 140) of the titration apparatus, may measure final mass of the contents using the electronic balance (e.g., the electronic balance 150), and may determine whether a target specification is satisfied based on the final pH and the final mass.

The sensor module may include at least one of a pH sensor (e.g., the pH sensor 141) configured to measure the pH of the contents, a temperature sensor (e.g., the temperature sensor 144) configured to measure temperature of the contents, and a stirrer (e.g., a stirrer 145) configured to mix the contents.

The titration apparatus may rinse the sensor module of the titration apparatus using a rinsing space (e.g., the rinsing space 170) of the titration apparatus, may dry the sensor module after rinsing the sensor module using a drying space (e.g., the drying space 180) of the titration apparatus, and may store the sensor module after drying the sensor module using a storage space (e.g., the storage space 190) of the titration apparatus.

Referring to FIG. 11, in an operation 1110, a titration apparatus (e.g., a controller such as the controller 160) may measure initial mass of contents of a sample container (e.g., the sample container 111) containing a sample using an electronic balance (e.g., the electronic balance 150) of the titration apparatus. In an operation 1120, the titration apparatus may inject a titrant (e.g., the titrant 121a) into the sample container using a first reagent pump (e.g., the first reagent pump 125) of the titration apparatus until the contents of the sample container exceed an equivalence point. In an operation 1130, the titration apparatus may measure a number of moles of the titrant in the contents at a moment when the contents reach the equivalence point. In an operation 1140, the titration apparatus may determine concentration of an analyte in the contents based on the number of moles of the titrant, a molecular weight of the analyte, and the initial mass.

The concentration of the analyte in the contents may be determined (e.g., by the controller 160) by dividing a product of the number of moles of the titrant and the molecular weight of the analyte by the initial mass.

The titration apparatus may rinse a sensor module (e.g., the sensor module 140) of the titration apparatus using a rinsing space (e.g., the rinsing space 170) of the titration apparatus, may dry the sensor module after rinsing the sensor module using a drying space (e.g., the drying space 180) of the titration apparatus, and may store the sensor module after drying the sensor module using a storage space (e.g., the storage space 190) of the titration apparatus.

In addition, the descriptions provided with reference to FIGS. 1 to 9 may apply to the titration methods of FIGS. 10 and 11.

According to embodiments, the controller 160 may be configured to control and/or receive signals from various components (e.g., the first reagent pump 125, the second reagent pump 135, the sensor module 140, the electronic balance 150, the discharge valve 172, the rinsing pump 175, the high-pressure nozzle 181, the gantry robot 910, etc.) of the titration apparatus 100 to cause the components to perform their respective functions and/or to perform one or more (e.g., some or all) of the methods described above with reference to FIGS. 1-11. For example, the controller 160, via controlling of and/or receiving signals from the various components, may be configured to perform the operations of the methods described above with reference to FIGS. 1-11. For example, the controller 160 may perform the various measuring, injecting, and determining operations of the methods described above with reference to FIGS. 1-11.

The example embodiments described herein may be implemented using a hardware component, a software component and/or a combination thereof. The controller 160 may be implemented using one or more general-purpose or special-purpose computers, such as, for example, a processor, and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium. According to embodiments, the controller 160 may include the machine, component, physical or virtual equipment, or computer storage medium or device.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although non-limiting example embodiments of the disclosure have been described with reference to the accompanying drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents, including the various technical modifications and variations, are within the spirit and scope of disclosure.

What is claimed is:

1. A titration apparatus comprising:
an index table configured to support a sample container containing a sample;
one or more reagent pumps configured to inject one or more reagents into the sample container;
one or more sensors configured to measure characteristics of contents of the sample container including the sample;
an electronic balance configured to support the sample container and measure a mass of the contents; and
a controller configured to perform a titration process using at least one of the one or more reagent pumps, at least one of the one or more sensors, and the electronic balance.

2. The titration apparatus of claim 1, wherein the controller is further configured to perform, based on the mass of the contents measured by the electronic balance, at least one of a potential of hydrogen (pH) titration process and a concentration titration process.

3. The titration apparatus of claim 1, wherein the controller is configured to:
measure, with the electronic balance, an initial mass of the contents; and
perform a potential of hydrogen (pH) titration process based on the initial mass.

4. The titration apparatus of claim 3, wherein the one or more reagent pumps comprises a plurality of reagent pumps, and the one or more reagents comprises a plurality of reagents, and
wherein the controller is further configured to perform the pH titration process by:
injecting, by controlling a first reagent pump of the plurality of reagent pumps, a titrant among the plurality of reagents into the sample container until a pH of the contents becomes an intermediate pH, the intermediate pH being different from an initial pH of the contents and a target pH of the contents;
injecting, by controlling a second reagent pump among the plurality of reagent pumps after the injecting the titrant, ultrapure water among the plurality of reagents into the sample container until the mass of the contents reaches a target mass; and
injecting, by controlling the first reagent pump after the injecting the ultrapure water, the titrant into the sample container until the pH of the contents reaches the target pH.

5. The titration apparatus of claim 4, wherein the controller is further configured to determine an injection amount of the ultrapure water by subtracting the initial mass and a first injection amount of the titrant from the target mass.

6. The titration apparatus of claim 3, wherein the controller is configured to:
measure, with the one or more sensors, a final pH of the contents according to the pH titration process;
measure, with the electronic balance, a final mass of the contents according to the pH titration process; and
determine whether a target specification is satisfied based on the final pH and the final mass.

7. The titration apparatus of claim 1, wherein the controller is configured to:
measure, with the electronic balance, an initial mass of the contents; and
perform a concentration titration process based on the initial mass.

8. The titration apparatus of claim 7, wherein the one or more reagent pumps comprises a plurality of reagent pumps, and the one or more reagents comprises a plurality of reagents, and
the controller is further configured to:
inject, by controlling a first reagent pump of the plurality of reagent pumps, a titrant among the plurality of reagents into the sample container until the contents exceed an equivalence point;
measure a number of moles of the titrant in the contents at a moment when the contents reach the equivalence point; and
determine a concentration of an analyte in the contents based on the number of moles of the titrant, a molecular weight of the analyte, and the initial mass.

9. The titration apparatus of claim 8, wherein the controller is further configured to determine the concentration of the analyte in the contents by dividing a product of the number of moles of the titrant and the molecular weight of the analyte by the initial mass.

10. The titration apparatus of claim 1, wherein the one or more sensors comprises at least one of a potential of hydrogen (pH) sensor configured to measure a pH of the contents, a temperature sensor configured to measure temperature of the contents, and a stirrer configured to mix the contents.

11. The titration apparatus of claim 1, further comprising:
a rinsing space configured to rinse the one or more sensors;
a drying space configured to dry the one or more sensors after rinsing the one or more sensors; and
a storage space configured to store the one or more sensors after drying the one or more sensors.

12. The titration apparatus of claim 11, further comprising:
a rinsing pump configured to inject a rinsing solution,
wherein the rinsing space is configured to rinse the one or more sensors with the rinsing solution injected by the rinsing pump.

13. A titration method performed by a titration apparatus, the titration method comprising:
measuring, by an electronic balance of the titration apparatus, an initial mass of contents of a sample container containing a sample;
injecting, by a first reagent pump of the titration apparatus, a titrant into the sample container until a potential of hydrogen (pH) of the contents of the sample container becomes an intermediate pH, the intermediate pH being different from an initial pH of the contents and a target pH of the contents;
injecting, by a second reagent pump of the titration apparatus after the injecting the titrant, ultrapure water into the sample container until a mass of the contents reaches a target mass; and
injecting, by the first reagent pump after the injecting the ultrapure water, the titrant into the sample container until the pH of the contents reaches the target pH.

14. The titration method of claim 13, further comprising:
determining an injection amount of the ultrapure water by subtracting the initial mass of the contents and a first injection amount of the titrant from the target mass.

15. The titration method of claim 13, further comprising:
measuring, by a one or more sensors of the titration apparatus, a final pH of the contents;
measuring, by the electronic balance, a final mass of the contents; and
determining whether a target specification is satisfied based on the final pH and the final mass.

16. The titration method of claim 15, wherein the one or more sensors comprises at least one of a pH sensor configured to measure the pH of the contents, a temperature sensor configured to measure a temperature of the contents, or a stirrer configured to mix the contents.

17. The titration method of claim 13, further comprising:
rinsing, by a rinsing space of the titration apparatus, a one or more sensors of the titration apparatus;
drying, by a drying space of the titration apparatus, the one or more sensors after the rinsing; and
storing, by a storage space of the titration apparatus, the one or more sensors after the drying.

18. A titration method performed by a titration apparatus, the titration method comprising:
measuring, by an electronic balance of the titration apparatus, an initial mass of contents of a sample container containing a sample;
injecting, by a first reagent pump of the titration apparatus, a titrant into the sample container until the contents of the sample container exceed an equivalence point;
measuring a number of moles of the titrant in the contents at a moment when the contents reach the equivalence point; and
determining a concentration of an analyte in the contents based on the number of moles of the titrant, a molecular weight of the analyte, and the initial mass.

19. The titration method of claim 18, further comprising:
determining the concentration of the analyte in the contents by dividing a product of the number of moles of the titrant and the molecular weight of the analyte by the initial mass.

20. The titration method of claim 18, further comprising:
rinsing, by a rinsing space of the titration apparatus, a one or more sensors of the titration apparatus;
drying, by a drying space of the titration apparatus, the one or more sensors after the rinsing; and
storing, by a storage space of the titration apparatus, the one or more sensors after the drying.
